(19) United States
(12) Patent Application Publication
(10) Pub. No.: US 2018/0026801 A1
(43) Pub. Date: Jan. 25, 2018

(54) Waveguide With Dielectric Light Reflectors

(71) Applicant: Massachusetts Institute Of Technology, Cambridge, MA (US)

(72) Inventors: Michael W. Geis, Acton, MA (US); Joshua I. Kramer, Branchburg, NJ (US); Karen M.G.V. Gettings, Carlisle, MA (US); Marc J. Burke, Pelham, NH (US); Mankuan M. Vai, Sudbury, MA (US)

(21) Appl. No.: 15/548,023

(22) PCT Filed: Feb. 29, 2016
(86) PCT No.: PCT/US2016/020044

§ 371 Date: Aug. 1, 2017

Related U.S. Application Data
(60) Provisional application No. 62/130,090, filed on Mar. 9, 2015.

(51) Int. Cl. H04L 9/32; H04L 9/08; G02B 6/42

(52) U.S. Cl. CPC H04L 9/3278; G02B 6/4214; G02B 6/4298; H04L 9/0852

(57) ABSTRACT

An improved waveguide is disclosed. The waveguide comprises four or five layers, an inner core polymer, one or two layers of outer cladding polymer either on one side of the core of sandwiching the inner core polymer, and two layers of a dielectric reflector sandwiching the outer cladding polymer. The refractive index of the inner core polymer is greater than that of the outer cladding polymer. Further, the refractive index of the outer cladding polymer is greater than that of the dielectric reflector. Further, the waveguide can be used to create a physically unclonable function. A light source and an image sensor may be disposed on a printed circuit board. The waveguide may be disposed on the printed circuit board so that light emitted from the light source traverses the waveguide before reaching the image sensor.

This application claims priority to U.S. Provisional Patent Application Ser. No. 62/130,090, filed Mar. 9, 2015, the disclosure of which is incorporated by reference in its entirety.

This invention was made with Government support under Contract No. FA8721-05-C-0002, awarded by the U.S. Air Force. The Government has certain rights in the invention.

### FIELD

This disclosure relates to waveguides used for physically unclonable functions applicable on fully functional printed circuit boards.

### BACKGROUND

Security is becoming increasingly important as the internet and electronic devices become more pervasive. For example, computers and even mobile telephones are equipped with biometrics to prevent access by unauthorized users.

Encryption is also used to prevent unauthorized access to devices and information. For example, data can be encrypted before being transmitted on the internet. Other techniques, such as security tokens, are also employed to limit access to devices.

In addition, many electronic systems require a unique digital identifier for authentication, key derivation and other purposes. These electronic systems are often manufactured using traditional manufacturing processes. Creating a unique digital identifier in this environment is often difficult and time consuming. Furthermore, to be effective, the unique digital identifier should be extremely different or nearly impossible to determine and copy.

One method of creating this unique digital identifier is through the use of waveguides. FIG. 1 shows a cross section of a printed circuit board 10 with a conventional planar waveguide 20. The printed circuit board 10 includes one or more light sources 11. These light sources 11 emit light that enters the waveguide 20 by means of angle mirror 26 cut into the waveguide. The light initially appears in both the inner core 21 and the outer cladding 22, but an absorptive layer of material 25 absorbs the light in the outer cladding 22. The printed circuit board 10 also includes an image sensor 12, such as a CCD image sensor. Light in the inner core 21 is not coupled to the image sensor 12, but inhomogeneities 27 in the inner core 21 scatter light into the outer cladding 22 where some fraction of this light is received by the image sensor 12. Thus, some portion of the light emitted from the light sources 11 reaches the image sensor 12. The light pattern created on the image sensor 12 is then converted to a digital value. Slight differences in the structure of the waveguide 20 affect the resulting light pattern, causing unique patterns to be reflected onto the image sensor 12. Thus, the light pattern represents the unique identifier.

As mentioned above, these waveguides 20 are traditionally constructed using an inner core 21 surrounded by an outer cladding 22. The outer cladding 22 is then covered by a reflective silver layer 24. The inner core 21 may have a higher refractive index (n) than the outer cladding 22. For example, the inner core 21 may have a refractive index of 1.59, while the outer cladding 22 has a refractive index of 1.49. Light is reflected at the boundary between the inner core 21 and the outer cladding 22 or at the boundary between the outer cladding 22 and the silver layer 24.

As shown in FIG. 1, the incident angle of the light determines which boundary the light is reflected at. Higher incident angle light is reflected at the boundary between the inner core 21 and the outer cladding 22, while lower incident angle light is reflected at the silver layer 24. For example, using the refractive indices described above, light with an incident angle of 70° to 90° will remain trapped in the inner core 21. Light with a lower incident angle, such as 60° to 70° pass through both the inner core 21 and the outer cladding 22. Further, at incident angles less than roughly 60°, the light will exit the outer cladding 22.

Therefore, the silver layer 24 provides an important function. First, it serves to keep most of the light within the waveguide 20, allowing all of this light to contribute to the light pattern received at the image sensor 12. Specifically, the silver layer 24 reflects light at lower incident angles that would be otherwise lost. Further, invasive techniques to determine the digital identifier cause disturbances to the silver layer 24 and scatter light from the inner core 21 into the outer cladding 22, both of which change the light pattern. For example, an intrusive probe inserted into the waveguide 20 will disturb the silver layer 24, outer cladding 22 and inner core 21 causing the light to be reflected differently. This difference changes the light pattern received at the image sensor 12, causing the electronic identification to fail.

However, the process of applying a silver coating to a waveguide is labor intensive and expensive. For example, the manufacturing of silver reflectors requires special processing using either vacuum evaporation or plating in an aqueous solution. Vacuum evaporation is expensive and can compromise electrical components. Plating increases the possibility of corrosion and can result in low reflectivity films.

Therefore, it would be beneficial if there were a system and method for creating a unique digital identifier which was easier to manufacture. Further, it would be advantageous if this new waveguide contained more of the light than is currently contained by the silver coating.

### SUMMARY

An improved waveguide is disclosed. The waveguide comprises four or five layers: an inner core; one or two layers of outer cladding, either on one side of the inner core or sandwiching the inner core, and two layers of a dielectric reflector sandwiching the outer cladding. The refractive index of the inner core is greater than that of the outer cladding. Further, the refractive index of the outer cladding is greater than that of the dielectric reflector. Further, the waveguide can be used to create a physically unclonable function. A light source and an image sensor may be disposed on a printed circuit board. The waveguide may be disposed on the printed circuit board so that light emitted from the light source traverses the waveguide before reaching the image sensor.

According to one embodiment, a waveguide is disclosed. The waveguide comprises an inner core, having a first refractive index; an outer cladding, sandwiching the inner core, having a second refractive index less than the first refractive index; and a dielectric reflector, sandwiching the outer cladding, having a third refractive index less than the second refractive index. In certain embodiments, the outer surface of the dielectric reflector is covered with a metallic layer. In certain embodiments, the outer surface of the dielectric reflector is covered with a second dielectric reflector. According to a further embodiment, a physically unclonable function is disclosed, which comprises the waveguide described above, disposed on a printed circuit board, wherein the printed circuit board comprises a light source for emitting a light into the waveguide; and an image sensor for receiving a light pattern created by the light traversing the waveguide. In certain embodiments, the printed circuit board further comprises a processing unit, a memory element containing encrypted code to be executed by the processing unit and a decryption circuit to decrypt the encrypted code stored in the memory element. In certain embodiment, the processing unit and the decryption circuit are disposed beneath the waveguide. In certain embodiments, the memory element is also disposed beneath the waveguide.

According to another embodiment, a waveguide is disclosed. The waveguide comprises an inner core, having a first refractive index, a first surface and a second surface; an outer cladding, covering at least a portion of the first surface of the inner core, having a second refractive index less than the first refractive index; and a dielectric reflector, covering the outer cladding and the second surface of the inner core, having a third refractive index less than the second refractive index. In certain embodiments, the outer surface of the dielectric reflector is covered with a metallic layer. In certain embodiments, the outer surface of the dielectric reflector is covered with a second dielectric reflector. According to a further embodiment, a physically unclonable function is disclosed, which comprises the waveguide described above, disposed on a printed circuit board, wherein the printed circuit board comprises a light source for emitting a light into the waveguide; and an image sensor for receiving a light pattern created by the light traversing the waveguide. In certain embodiments, the printed circuit board further comprises a processing unit, a memory element containing encrypted code to be executed by the processing unit and a decryption circuit to decrypt the encrypted code stored in the memory element, wherein the processing unit and the decryption circuit are disposed beneath the waveguide.

### BRIEF DESCRIPTION OF THE DRAWINGS

For a better understanding of the present disclosure, reference is made to the accompanying drawings, which are incorporated herein by reference and in which:

FIG. 1 shows a printed circuit board with a waveguide according to the prior art;

FIGS. 2A-2C shows a waveguide according to various embodiments;

FIG. 3 shows a comparison of the reflected light intensity of a silver layer and a dielectric reflector as a function of incident angle; and

FIG. 4A shows a cross-sectional view of a printed circuit board with the waveguide of FIG. 2A, and FIG. 4B shows a top view of the printed circuit board.

### DETAILED DESCRIPTION

The present disclosure describes a waveguide that may be used with fully fabricated printed circuit boards to create a physically unclonable function. The waveguide utilizes multiple dielectric materials to create the desired reflections within the waveguide. Further, the waveguide achieves increased reflectivity as compared to prior art waveguides.

As described above, traditional waveguides may use a silver coating to help contain the light within the waveguide. In contrast, the present waveguide uses a third polymer.

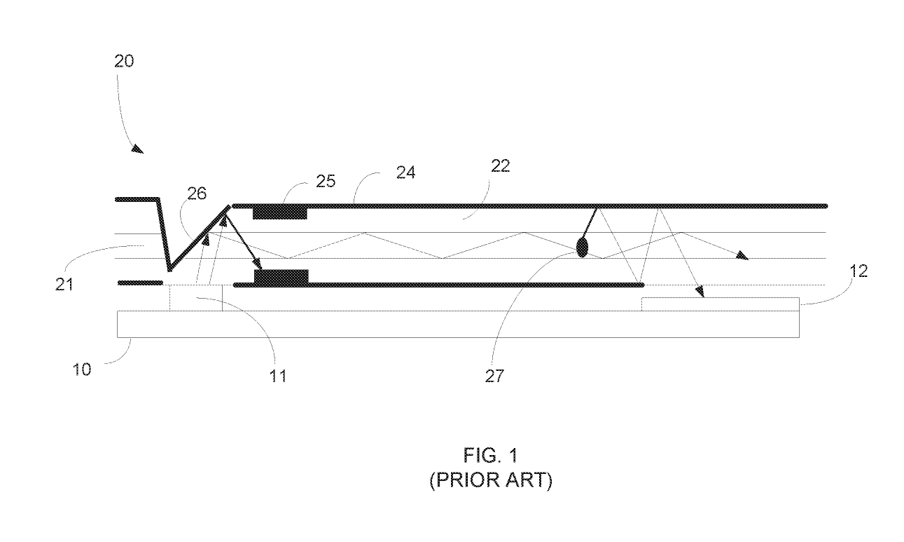

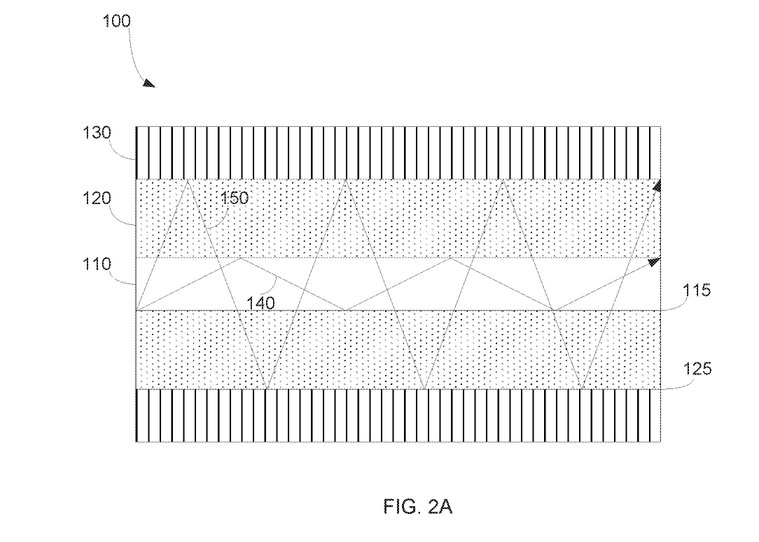

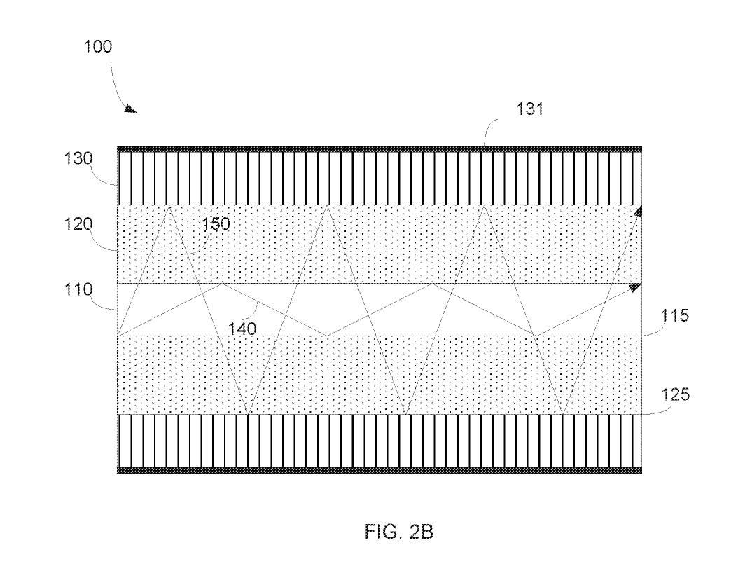

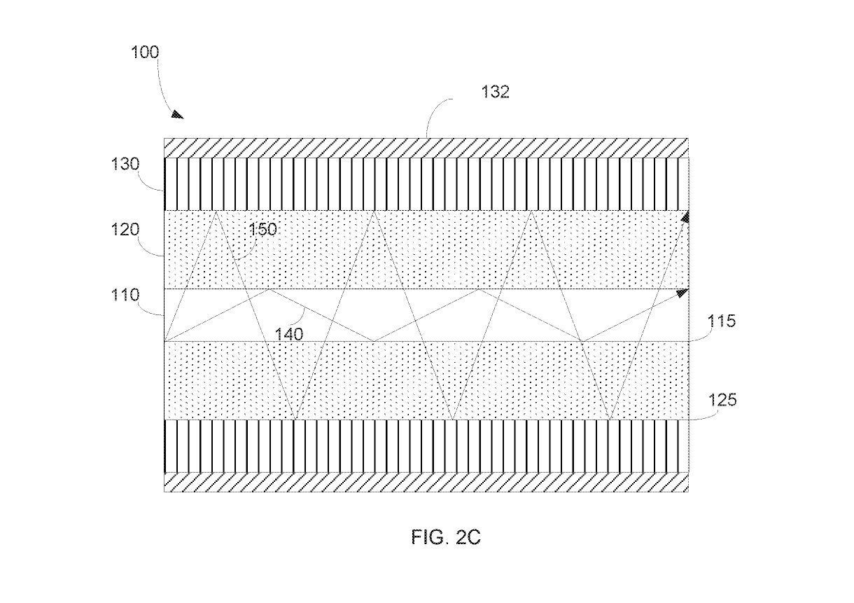

FIG. 2A shows a cross-sectional view of a waveguide 100 according to one embodiment. Like the waveguide of FIG. 1, the waveguide 100 includes an inner core 110. The waveguide 100 also includes an outer cladding 120 that covers at least a portion of the inner core 110. In some embodiments, the outer cladding 120 covers one side of the inner core 110. In other embodiments, the outer cladding 120 comprises two layers that sandwich the inner core 110. In other words, in certain embodiments, there are two layers of outer cladding 120, where one layer is disposed on each side of the inner core 110. However, unlike the waveguide of FIG. 1, the waveguide of FIG. 2A does not utilize a silver reflective layer. Rather, a dielectric reflector 130 is used to cover the outer cladding 120. In other words, the dielectric reflector 130 sandwiches the outer cladding 120. There are two layers of dielectric reflector 130, one adjacent to each layer of the outer cladding 120. Thus, the waveguide 100 comprises a set of four or five layers, depending on whether the outer cladding 120 is used on both sides of the inner core 110. When there are five layers, these layers are, in order, a first dielectric reflector 130, a first outer cladding 120, an inner core 110, a second outer cladding 120 and a second dielectric reflector 130. When there are four layers, these layers are, in order, a first dielectric reflector 130, a first outer cladding 120, an inner core 110 and a second dielectric reflector 130.

The inner core 110, the outer cladding 120 and the dielectric reflector 130 may be polymers. The three polymers used in the waveguide 100 each have different refractive indices, with the inner core 110 having the highest index and the dielectric reflector 130 having the lower index. The inner core 110 and the outer cladding 120 meet at an inner interface 115, while the outer cladding 120 and the dielectric reflector 130 meet at an outer interface 125. In other embodiments, one or more of the layers may be a transparent material.

Each of the layers of the waveguide 100 may be planar, where each layer is a thin rectangular prism. Further, the layers are stacked on top of each other.

As described above, light with a high incident angle 140 stays within the inner core 110, while light with a lower incident angle 150 is contained within the outer cladding 120 and the inner core 110.

Dielectric reflectors may be very efficient, especially for S-polarized light and P-polarized light with incident angles between 60° and 70°. Further, the reflectivity of dielectric reflectors at this range of incident angles is better than that of silver. Thus, the waveguide 100 of FIG. 2 transports light more efficiently by a factor of 2 or more to the image sensor than the convention waveguide 20 shown in FIG. 1.

In one embodiment, the inner core 110 has a refractive index of 1.59, while the outer cladding 120 has a refractive index of 1.49. The dielectric reflector 130 may have a refractive index of, for example, 1.40. Of course, any value less than that of the outer cladding 120 may be used, but lower refractive indices may be more beneficial.

According to Snell's Law, the light will be completely reflected if the angle of incidence satisfies the equation:

arcsin(θ)>n₂/n₁,

where n₂ is the refractive index of the outer material and the n₁ is the refractive index of the inner material.

If the inner core 110 has a refractive index of 1.59, and the outer cladding 120 has a refractive index of 1.49, then all light having an angle of incidence of at least 70° at the inner interface 115 will be completely reflected within the inner core 110.

According to Snell's Law, as light passes from one medium to a second medium having a different refractive index, the angle of incidence changes according to the equation:

n₁ sin θ₁=n₂ sin θ₂,

where n₁ is the refractive index and θ₁ is the incident angle of the first medium, and n₂ is the refractive index and θ₂ is the incident angle of the second medium.

Since the outer cladding 120 has a lower refractive index than the inner core 110, light having an angle of incidence of less than 70° at the inner interface 115 will be refracted at a greater angle. For example, light have an incident angle of approximately 60° at the inner interface 115 will be refracted at an angle of 70°.

Similarly, if the dielectric reflector 130 has a refractive index of 1.40, then all light having an angle of incidence of at least 70° at the outer interface 125 will be reflected. Thus, any light having an angle of incidence of at least 60° at the inner interface 115 will be completely contained within waveguide 100. If the dielectric reflector 130 has a refractive index of 1.3, all light having an angle of incidence of at least 55° at the inner interface 115 will be contained within the waveguide 100. Similarly, if the dielectric reflector 130 has a refractive index of 1.2, all light having an angle of incidence of at least 49° at the inner interface 115 will be contained within the waveguide 100.

In one embodiment, the inner core 110 may be an epoxy core, the outer cladding 120 may be a urethane cladding and the dielectric reflector 130 may be polydimethylsiloxane (PDMS). Further, in certain embodiments, the dielectric reflector 130 is the outermost layer. In other words, there are no other layers on the outer surface of the dielectric reflector 130.

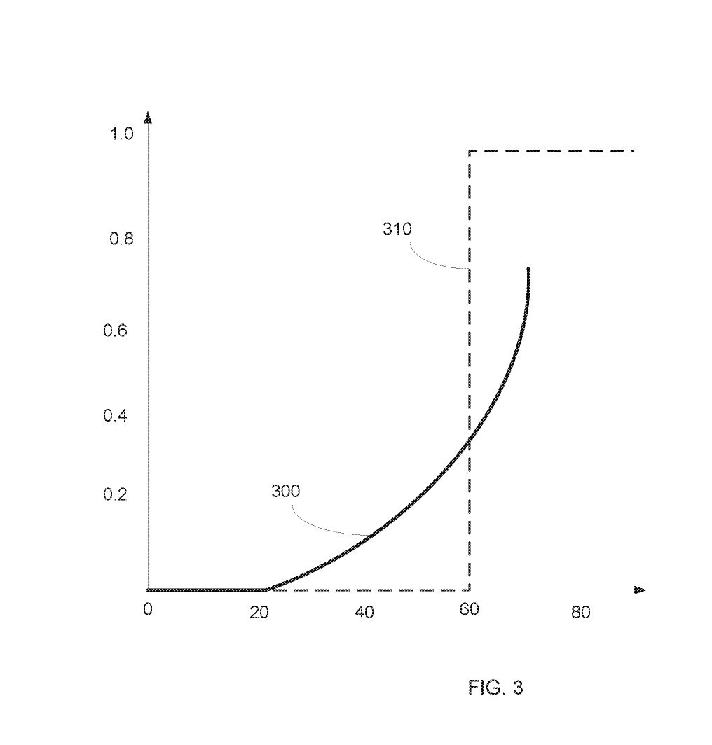

While the dielectric reflector 130 reflects all of the light having an incident angle that is greater than a threshold value, the same is not true for the silver layer. Silver reflects between about 97% and 98% of the light having an angle of incidence between 40° and 80°. In a waveguide, the light is reflected many times as it traverses the waveguide. If the light is reflected r times, the actual percentage of light that is ultimately received at the image sensor is, at best, (0.98)^{r}. If there are 20 reflections, the actual light reflected is less than 66% of the original light. FIG. 3 shows a comparison of reflected light intensity, as a function of incident angle, for both a silver layer and a dielectric reflector. This data represents the reflected light intensity after travelling 8 cm in a waveguide.

Line 300 shows the reflected light intensity of a conventional silver layer. At low angles of incidence, the reflected light intensity is very low, as the light is reflected more times than higher incident angle light. Thus, in the range of incident angles between 40° and 60°, the silver layer reflects only up to about 35% of the total light. At incident angles between 60° and 70°, the silver layer reflects between 40% and 75% of the total light. In contrast, the dielectric reflector, shown in line 310, reflects 100% of the light at incident angles greater than 60° and none of the light at lower angles. In other words, the dielectric reflector 130 reflects far more light having an incident angle of 60° or more. At incident angles less than 60°, the silver layer reflects more light; however, the intensity of the light at these lower incident angles is far less than 40%. Therefore, in total, the dielectric reflector 130 reflects more light than the silver layer.

While FIG. 2A shows the dielectric reflector 130 as being the outermost layer, other embodiments are also possible. For example, as shown in FIG. 2B, in one embodiment, a metallic layer 131 is applied on the outer surfaces of the dielectric reflector 130. The metallic layer 131 may be a silver layer, or another metal. The metallic layer 131 may be applied on both outer surfaces or only one outer surface of the dielectric reflector 130.

In yet another embodiment, shown in FIG. 2C, a second dielectric reflector 132 is applied on the outer surfaces of the dielectric reflector 130. The second dielectric reflector 132 may have a lower or higher refractive index than the dielectric reflector 130. The second dielectric reflector 132 may be applied on both outer surfaces or only one outer surface of the dielectric reflector 130.

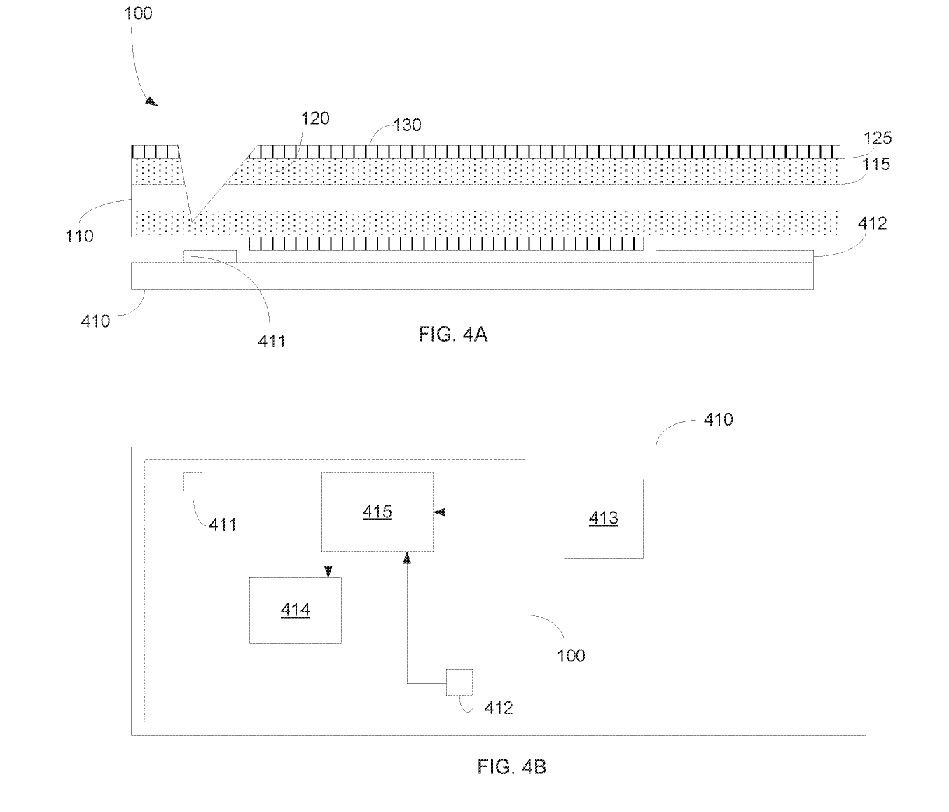

FIG. 4A shows a cross section of a printed circuit board having the waveguide 100 of FIG. 2A. FIG. 4B shows a top view of the printed circuit board. As shown in FIG. 4A, the waveguide 100 is disposed on top of the printed circuit board 410. A light source 411 is used to inject light into the waveguide 100. The reflected light is received by an image sensor 412, disposed on the printed circuit board 410, separate from the light source 411. FIG. 4B shows a top view of the printed circuit board 410. In certain embodiments, the waveguide 100 (shown in dashed lines) is used to cover several components disposed on the printed circuit board 410. Disposed on the printed circuit board is a memory element 413 that contains the code executed by the processing unit 414. In operation, the code in the memory element 413 may be encrypted, where the key needed to decrypt the code is defined by the light pattern at the image sensor 412. In some embodiments, a decryption circuit 415 is also disposed on the printed circuit board 410. The decryption circuit 415 uses the light pattern from the image sensor 412 as the key to decrypt the code, and then passes this decrypted code to the processing unit 414. To protect the security and confidentiality of the code, certain components on the printed circuit board 410 are covered by the waveguide 100. For example, the processing unit 414, which receives decrypted code may be covered by the waveguide 100. In addition, the decryption circuit 415, which outputs decrypted code, may also be covered by the waveguide 100. The memory element 413 may optionally also be covered by the waveguide 100. In other words, decrypted code and the light pattern output from the image sensor 412 remain hidden under the waveguide 100. Additionally, the light source 411 and the image sensor 412 are located beneath the waveguide 100.

In this way, if one were to attempt to interrogate the printed circuit board 410 to gain access to the decrypted code, one would necessarily have to pierce or remove the waveguide 100. However, any manipulation of the waveguide 100 will affect the way that light is reflected within the waveguide 100, thereby affecting the light pattern received at the image sensor 412. This change in the light pattern modifies the key, and renders the circuit unusable. Thus, the waveguide of FIG. 2A may be used to create a physically unclonable function (PUF) on a printed circuit board. Likewise, the waveguides of FIGS. 2B-2C may also be used to create a physically unclonable function (PUF) on a printed circuit board.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Furthermore, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A waveguide, comprising:
an inner core, having a first refractive index;
an outer cladding, sandwiching the inner core, having a second refractive index less than the first refractive index; and
a dielectric reflector, sandwiching the outer cladding, having a third refractive index less than the second refractive index.

2. The waveguide of claim 1, wherein the dielectric reflector has a refractive index of 1.40 or less.

3. The waveguide of claim 1, wherein the dielectric reflector comprises polydimethylsiloxane.

4. The waveguide of claim 1, wherein the first refractive index is about 1.59 and the second refractive index is about 1.49.

5. The waveguide of claim 1, wherein the inner core and the outer cladding comprise polymers.

6. The waveguide of claim 1, wherein an outer surface of the dielectric reflector is covered with a metallic layer.

7. The waveguide of claim 1, wherein an outer surface of the dielectric reflector is covered with a second dielectric reflector.

8. A physically unclonable function, comprising:
the waveguide of claim 1, disposed on a printed circuit board;
wherein the printed circuit board comprises:
a light source for emitting a light into the waveguide; and
an image sensor for receiving a light pattern created by the light traversing the waveguide.

9. The physically unclonable function of claim 8, wherein the printed circuit board further comprises:
a processing unit;
a memory element containing encrypted code to be executed by the processing unit; and
a decryption circuit to decrypt the encrypted code stored in the memory element.

10. The physically unclonable function of claim 9, wherein the processing unit and the decryption circuit are disposed beneath the waveguide.

11. The physically unclonable function of claim 10, wherein the memory element is disposed beneath the waveguide.

12. A waveguide, comprising:
an inner core, having a first refractive index, a first surface and a second surface;
an outer cladding, covering at least a portion of the first surface of the inner core, having a second refractive index less than the first refractive index; and
a dielectric reflector, covering the outer cladding and the second surface of the inner core, having a third refractive index less than the second refractive index.

13. The waveguide of claim 12, wherein the dielectric reflector has a refractive index of 1.40 or less.

14. The waveguide of claim 12, wherein the dielectric reflector comprises polydimethylsiloxane.

15. The waveguide of claim 12, wherein the first refractive index is about 1.59 and the second refractive index is about 1.49.

16. The waveguide of claim 12, wherein the inner core and the outer cladding comprise polymers.

17. The waveguide of claim 12, wherein an outer surface of the dielectric reflector is covered with a metallic layer.

18. The waveguide of claim 12, wherein an outer surface of the dielectric reflector is covered with a second dielectric reflector.

19. A physically unclonable function, comprising:
the waveguide of claim 12, disposed on a printed circuit board;
wherein the printed circuit board comprises:
a light source for emitting a light into the waveguide; and
an image sensor for receiving a light pattern created by the light traversing the waveguide.

20. The physically unclonable function of claim 19, further comprising:
a processing unit;
a memory element containing encrypted code to be executed by the processing unit; and
a decryption circuit to decrypt the encrypted code stored in the memory element, wherein the processing unit and the decryption circuit are disposed beneath the waveguide.
